(19) United States
(12) Patent Application Publication
(10) Pub. No.: US 2020/0043443 A1
(43) Pub. Date: Feb. 6, 2020

(54) CORRECTION SYSTEM

(71) Applicant: SAKAI DISPLAY PRODUCTS CORPORATION, Sakai-shi, Osaka (JP)

(72) Inventors: IKUHISA TAKAO, Sakai-shi, Osaka (JP); TOMONORI TAKOBE, Sakai-shi, Osaka (JP); AKIYOSHI MIYATANI, Sakai-shi, Osaka (JP)

(21) Appl. No.: 16/340,249

(22) PCT Filed: Oct. 26, 2016
(86) PCT No.: PCT/JP2016/081777

§ 371 Date: Apr. 8, 2019

(51) Int. Cl. G09G 5/10

(52) U.S. Cl. CPC G09G 5/10; G09G 2360/145; G09G 2320/0233

(57) ABSTRACT

A correction system (1) generates correction data for correcting display unevenness of a display panel (2). The correction system is provided with a signal source (11), an image capture device (12), and a control device (13). The signal source outputs a signal for causing the display panel to display a prescribed reference image. The image capture device generates a captured image by capturing an image of the reference image displayed on the display panel on the basis of the signal. The control device generates correction data for the display panel on the basis of the captured image. The control device detects an abnormality of a display region in the captured image on the basis of a luminance difference which is the difference in luminance among a plurality of prescribed regions (Rb) included in the display region of the display panel in the captured image (S3).

### TECHNICAL FIELD

The present invention relates to a correction system for correcting display unevenness in a display panel.

### BACKGROUND ART

A conventional technique is known for correcting display unevenness such as unevenness in luminance or color of a display image in a display device including a display panel such as a liquid crystal panel (refer to Patent Literature 1, for example).

Patent Literature 1 discloses a correction system for correcting display unevenness of a display panel. The correction system according to Patent Literature 1 includes a signal source which supplies image data to the display panel, a camera which captures an image of a display area of the display panel, and a computer which generates correction data for the display panel based on the captured image. The correction system according to Patent Literature 1 uses a volatile storage device, such as DRAM included in a display device, as a storage device to store the correction data in order to shorten time for writing the correction data or time for deleting the correction data for each display device including the display panel.

### CITATION LIST

### Patent Literature

### Patent Literature 1

Patent Literature 1: International Patent Publication No. 2012/133890

### SUMMARY OF INVENTION

### Technical Problem

An objective of the present invention is to provide a correction system which generates correction data of display unevenness in display panels and is capable of easily preventing outflow of defective display panels.

### Solution to Problem

A correction system according to the present invention is a correction system which generates correction data for correcting display unevenness of a display panel. The correction system includes a signal source, an image capture device, and a control device. The signal source outputs a signal to cause a prescribed reference image to be displayed on the display panel. The image capture device generates a captured image by capturing an image of the reference image displayed on the display panel based on the signal. The control device generates correction data for the display panel based on the captured image. The control device detects an abnormality in a display area in the captured image based on luminance difference which is a difference in luminance between a plurality of prescribed areas included in the display area of the display panel in the captured image.

### Advantageous Effects of Invention

In the correction system according to the present invention, an abnormality in the display area in the captured image for generating correction data is detected based on luminance difference. Through the above, an outflow of defective display panels can be easily prevented by using the correction system which generates correction data of display unevenness of the display panels.

### BRIEF DESCRIPTION OF DRAWINGS

FIG. 1 is a block diagram illustrating an overall configuration of a correction system according to a first embodiment.

FIG. 2 is a block diagram illustrating a configuration of a PC in the correction system.

FIGS. 3A to 3C are diagrams for describing an overview of operation of abnormality detection in the correction system.

FIG. 4 is a flowchart depicting operation of the correction system according to the first embodiment.

FIG. 5 is a diagram for describing divisions of the correction data generated in the correction system.

FIG. 6 is a diagram illustrating a display example of an abnormality notification in the correction system.

FIG. 7 is a flowchart depicting an abnormality detection process in the correction system.

FIG. 8 is a diagram for describing divisions used to measure luminance difference in the abnormality detection process.

FIG. 9 is a flowchart depicting a first variation of the operation of the correction system.

FIG. 10 is a flowchart depicting a second variation of the operation of the correction system.

### DESCRIPTION OF EMBODIMENTS

The following describes a correction system according to embodiments of the present invention with reference to the accompanying drawings. Elements of configuration that are the same in the following embodiments are labeled with the same reference signs.

### First Embodiment

### 1. Configuration

The following describes a configuration of the correction system according to a first embodiment.

### 1-1. System Configuration

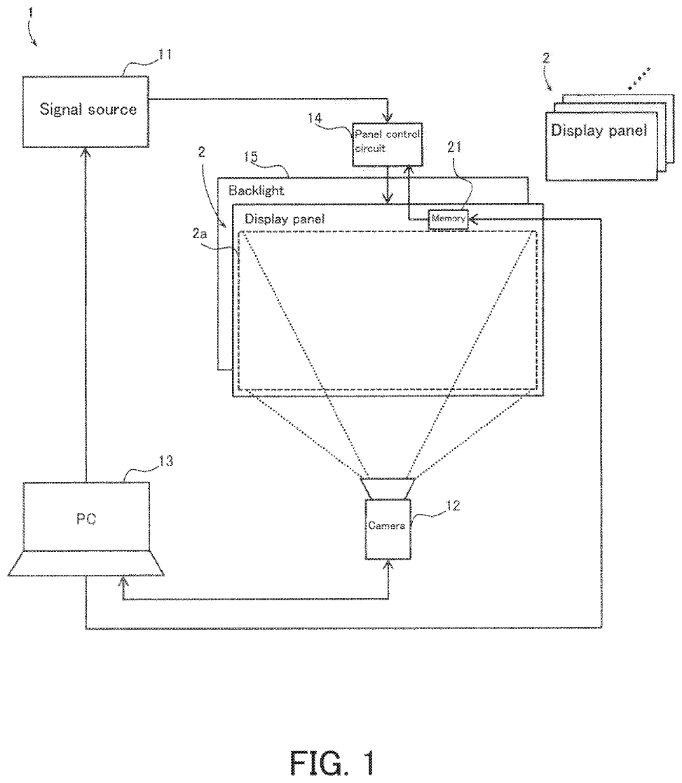

The following describes an overall configuration of the correction system according to the first embodiment with reference to FIG. 1. FIG. 1 is a block diagram illustrating the overall configuration of a correction system 1 according to the present embodiment.

As illustrated in FIG. 1, the correction system 1 according to the present embodiment includes a signal source 11, a camera 12, a personal computer (PC) 13, a panel control circuit 14, and a backlight 15. The correction system 1 is a system that performs settings for correcting display unevenness of an image displayed by each of a plurality of display panels 2 in for example manufacture or shipment of the display panels 2.

Each display panel 2 is for example an open cell liquid crystal panel, in which image display is controlled externally by the panel control circuit 14 or the like. A display panel 2 includes for example a display area 2a in which an image is displayed by a plurality of pixels arranged in a matrix. The display panel 2 includes memory 21 such as serial peripheral interface (SPI) flash memory. Characteristic information of the display panel 2, for example, is stored in the memory 21.

The signal source 11 is a signal-generating circuit which generates an image signal indicating an image (reference image) to be displayed on a display panel 2 undergoing processing by the correction system 1. Under the control of the PC 13 for example, the signal source 11 outputs the image signal to the panel control circuit 14.

The camera 12 includes an image sensor such as a charge-coupled device (CCD) or complementary metal-oxide-semiconductor (CMOS) image sensor and an image-capturing optical system such as a zoom lens and a focus lens. Under control of the PC 13 for example, the camera 12 captures an image shown in the display area 2a of the display panel 2 undergoing processing. The camera 12 generates captured image data indicating the captured image and outputs the generated captured image data to the PC 13. The camera 12 is an example of an image capture device according to the present embodiment.

The PC 13 controls operation of each section of the signal source 11, the camera 12, and the like in the correction system 1. The PC 13 is for example connected to the memory 21 of the display panel 2 through a prescribed interface circuit (not illustrated), and writes various information to the memory 21. The writing to the memory 21 by the PC 13 may be performed through the panel control circuit 14. The PC 13 is an example of a control device according to the present embodiment. The configuration of the PC 13 is described later in detail.

The panel control circuit 14 is a dedicated circuit for controlling image display of the display panel 2, and for example includes a microcomputer. The panel control circuit 14 in the correction system 1 is connected to the signal source 11 and the display panel 2 undergoing processing, and controls the image display of the display panel 2 based on the image signal from the signal source 11. As such, the panel control circuit 14 can read and use various information from the memory 21 of the display panel 2.

The backlight 15 is an illumination device that illuminates the display area 2a of the display panel 2 undergoing processing. The backlight 15 includes a light-emitting diode (LED), for example.

In the correction system 1 described as above, the panel control circuit 14 may be appropriately omitted in a case where a similar control circuit is included in the display panel 2. Furthermore, the backlight 15 may also be appropriately omitted from the correction system 1 in a case where a backlight is included in the display panel 2.

### 1-2. PC Configuration

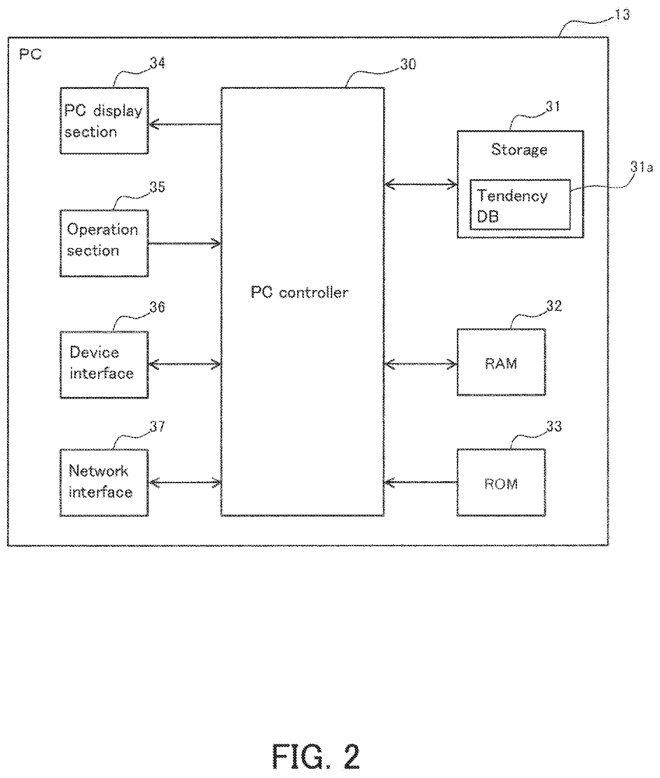

The following describes the configuration of the PC 13 according to the present embodiment in detail with reference to FIG. 2. FIG. 2 is a block diagram illustrating the configuration of the PC 13 in the correction system 1.

As illustrated in FIG. 2, the PC 13 includes a PC controller 30, storage 31, random-access memory (RAM) 32, read-only memory (ROM) 33, a PC display section 34, an operation section 35, a device interface (I/F) 36, and a network interface (I/F) 37.

The PC controller 30 is constituted for example by a central processing unit (CPU) or a microprocessor unit (MPU) which implements prescribed functions together with software, and controls overall operation of the PC 13. The PC controller 30 reads out data or programs stored in the storage 31 to perform various computing processes and implement various functions. For example, the PC controller 30 performs image analysis of the captured image indicated by the captured image data and generates information (correction data) for setting the display panel 2. The PC controller 30 also performs a process (abnormality detection process) to detect an abnormality while generating the information based on luminance difference in the captured image. Various programs such as programs for performing the abnormality detection process may be stored in the storage 31, stored on a portable storage medium, or provided from a network.

Note that the PC controller 30 may be a hardware circuit such as a dedicated electronic circuit or a reconfigurable electronic circuit designed to implement a prescribed function. The PC controller 30 may also be constituted by various semiconductor integrated circuits such as a CPU, and MPU, a microcomputer, a digital signal processor (DSP), a field-programmable gate array (FPGA), or an application-specific integrated circuit (ASIC).

The storage 31 is a storage medium which stores programs and data necessary to implement the functions of the PC 13. The storage 31 is constituted by a hard disk drive (HDD) or a semiconductor storage device (SSD), for example. The storage 31 stores therein a tendency database (DB) 31a (described later), for example.

The RAM 32 is constituted by for example a semiconductor device including dynamic RAM (DRAM), static RAM (SRAM), or the like, and temporarily stores data. The RAM 32 may also function as a work area of the PC controller 30. The RAM 32 stores therein captured image data and correction data, for example.

The ROM 33 stores therein programs executed by the PC controller 30 and fixed parameters, for example.

The PC display section 34 is constituted by a liquid crystal display or an organic electroluminescent (EL) display, for example. The PC display section 34 displays various information such as the captured image indicated by the captured image data, for example. The PC display section 34 is an example of a notification section according to the present embodiment.

The operation section 35 is a user interface on which a user performs operation. The operation section 35 is constituted by a keyboard, a touch pad, a touch panel, a button, a switch, or a combination thereof, for example.

The device interface 36 is a circuit (module) for connecting another device to the PC 13. The device interface 36 performs communication according to a prescribed communication standard. Examples of the prescribed communication standard include Universal Serial Bus (USB), HIGH-DEFINITION MULTIMEDIA INTERFACE (HDMI) (registered Japanese trademark), IEEE 1395, WiFi, and BLUETOOTH (registered Japanese trademark). The device interface 36 is for example connected to the signal source 11, and the camera 12.

The network interface 37 is a circuit (module) for connecting the PC 13 to a network through a wireless or wired communication line. The network interface 37 performs communication based on a prescribed communication standard. Examples of the prescribed communication standard include IEEE 802.3 and IEEE 802.11a/11b/11g/11ac. The signal source 11 and the camera 12 may also be connected to the PC 13 through the network interface 37.

### 2. Operation

The following describes operation of the correction system 1 configured as above.

### 2-1. Overview of Operation

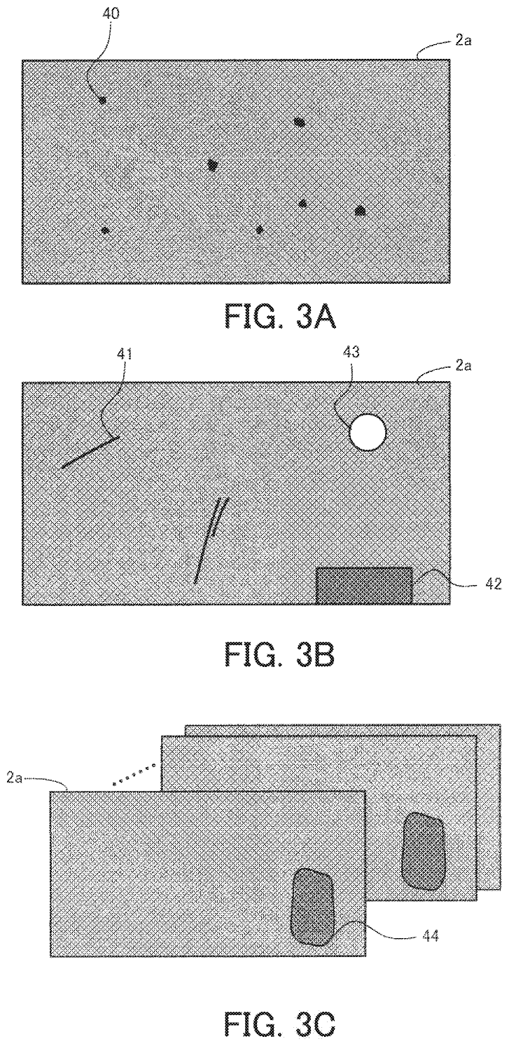

The following describes an overview of the operation of the correction system 1 according to the present embodiment using FIGS. 3A to 3C. FIGS. 3A to 3C are diagrams for describing an overview of an abnormality detection operation in the correction system 1.

The correction system 1 (FIG. 1) according to the present embodiment generates correction data based on the captured image of the display area 2a captured by the camera 12 for each display panel 2, and sets the generated correction data to a captured display panel 2. The correction data is data applied to correct display unevenness when the display panel 2 displays an image. The correction data for each display panel 2 is for example automatically generated by the PC 13 for correction of display unevenness recognized from luminance distribution in the display area 2a in the captured image of the display panel 2. Here, in the display area 2a in the captured image, for example, luminance difference caused by a main factor unrelated to display unevenness needing correction is thought to exist as described below.

FIG. 3A is an example of a captured image in a case where foreign objects 40 are attached to a display panel 2. In the correction system 1, foreign objects 40 such as dust and dirt may be attached to the display area 2a of the display panel 2. In such a case as illustrated in FIG. 3A, luminance difference unrelated to display unevenness of the display panel 2 is thought to exist between areas in which the foreign objects 40 are superimposed and areas in which the foreign objects 40 are not superimposed in the captured image.

FIG. 3B illustrates a case in which abnormal shapes are included as display unevenness in the display area 2a in the captured image. For example, due to a scratch in the laminate for protecting the display panel 2 as illustrated in FIG. 3B, a line 41 may exist in the display area 2a in the captured image. A rectangle 42 is thought to exist due to a shadow of an external member, and a circle 43 is thought to exist due to reflection of external light.

FIG. 3C illustrates a case where there is a defect tendency in luminance difference of the captured image of each display panel 2. For example, in cases for example where the backlight 15 (FIG. 1) is dirty or a foreign object is attached to the lens of the camera 12, a defect tendency is assumed in which luminance difference exists successively in identical positions (defect tendency area 44) in the display areas 2a in the captured images of the plurality of display panels 2, as illustrated in FIG. 3C.

In a case such as above, the correction data automatically generated by the correction system 1 may include errors such as misrecognition of luminance difference in the captured image, which is not due to display unevenness, as luminance difference due to display unevenness. When correction data including such an error is set to the display panels 2, the display panels 2 become defective, which may lead to an outflow of defective display panels 2 in manufacture or shipment.

In view of the foregoing, the correction system 1 according to the present embodiment detects a case where there is luminance difference that is not thought to be due to display unevenness such as the examples in FIGS. 3A to 3C as an abnormality in the display area 2a in the captured image in generation of correction data based on the captured image of each display panel 2. Through the above, in a case where an abnormality in the display area 2a in the captured image is detected in generation of the correction data for each display panel 2 in the correction system 1, generation of the correction data is stopped with a result that an outflow of defective display panels 2 can be obviated. The following describes the operation of the correction system 1 according to the present embodiment in detail.

### 2-2. Overall Operation

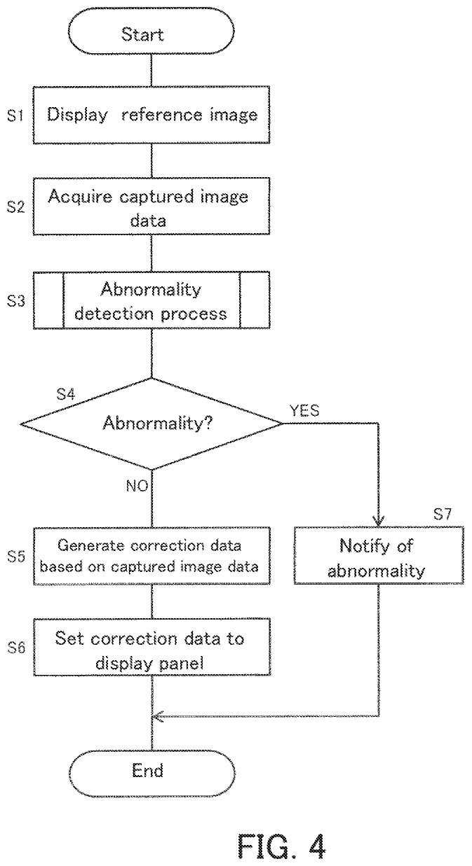

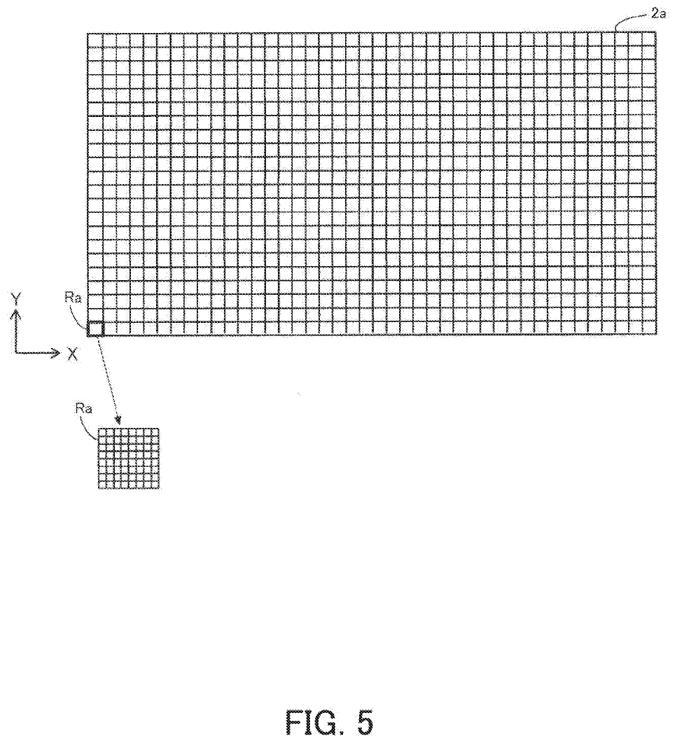

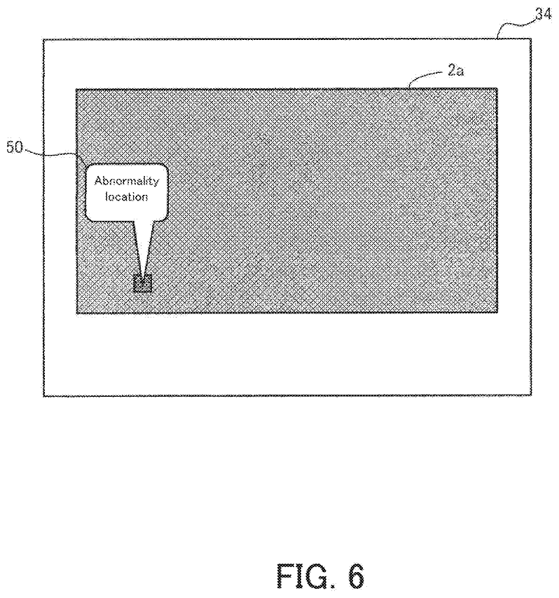

The following describes overall operation of the correction system 1 according to the present embodiment with reference to FIGS. 4, 5, and 6. FIG. 4 is a flowchart depicting operation of the correction system 1 according to the present embodiment. FIG. 5 is a diagram for describing divisions of the correction data generated in the correction system 1. FIG. 6 is a display example of abnormality notification in the correction system 1.

The flowchart of FIG. 4 depicts a process performed on each display panel 2 in the correction system 1. The flowchart begins in a state where a display panel 2 undergoing processing is connected to each section of the correction system 1 and seated. Each process depicted in the flowchart is performed by the PC 13 in the correction system 1.

First, the PC controller 30 of the PC 13 controls the signal source 11 (FIG. 1) to cause the reference image to be displayed on the display panel 2 undergoing processing (S1). The reference image is an image used as a reference for detecting display unevenness in the correction system 1, and is for example an image in which all pixels are set to a prescribed grayscale reference tone. The reference tone is for example set to an intermediate tone such as a tone value 100 among 256 tones.

In Step S1, the PC controller 30 transmits a reference image display instruction to the signal source 11 (FIG. 1). The signal source 11 generates the image signal of the reference image indicated by the received instruction and outputs the image signal to the panel control circuit 14. The panel control circuit 14 refers to information stored in the memory 21 of the display panel 2 undergoing processing and directs the display panel 2 to display the reference image based on the image signal from the signal source 11. An initial value “0” of preset correction data is stored in the memory 21. As such, the reference image is displayed in the display area 2a of the display panel 2 without any particular correction of display unevenness in Step S1.

Next, the PC controller 30 for example controls imaging operation through which the camera 12 captures the reference image displayed on the display panel 2 and acquires captured image data indicating the captured image of the captured reference image from the camera 12 (S2).

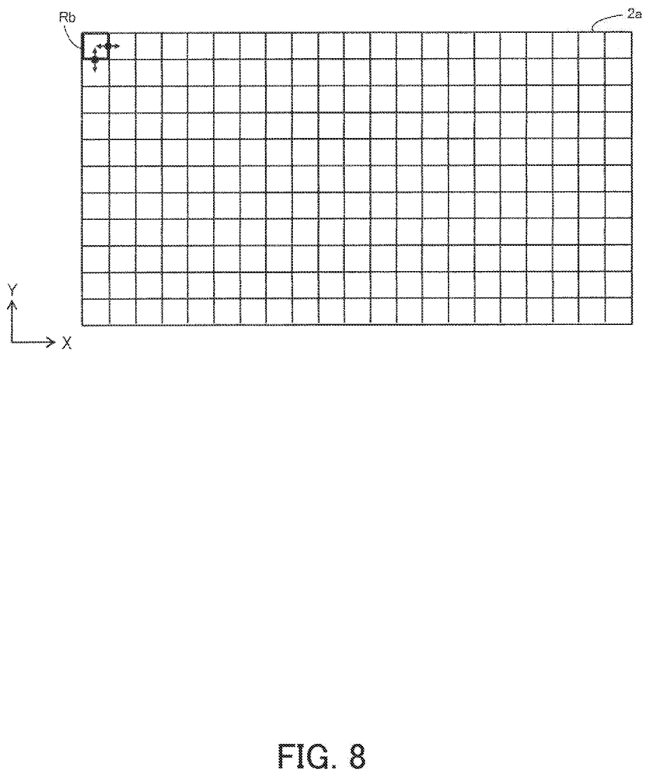

Next, the PC controller 30 performs the abnormality detection process based on the acquired captured image data (S3). The abnormality detection process is a process through which an abnormality is detected based on luminance difference in the display area 2a in the captured image indicated by the captured image data. In Step S3, the luminance difference is measured as a difference in luminance between a plurality of areas included in the display area 2a in the captured image (refer to FIG. 8). The abnormality detection process of Step S3 is described later in detail.

Next, the PC controller 30 determines whether or not an abnormality has been detected in the display area 2a in the captured image (S4) in the abnormality detection process of Step S3. For example, the PC controller 30 advances to “YES” in Step S4 in cases such as the examples of FIGS. 3A to 3C.

When determining that an abnormality has not been detected in the display area 2a in the captured image (NO in S4), the PC controller 30 generates correction data (S5) based on the captured image data acquired in Step S2. Divisions in the display area 2a for generating correction data are described with reference to FIG. 5.

FIG. 5 illustrates the arrangement of a plurality of divisions Ra in the display area 2a of the display panel 2. As illustrated in FIG. 5, the divisions Ra divide the display area 2a into a matrix. In the following, a row direction of the matrix in the display area 2a is referred to as an X direction and a column direction is referred to as a Y direction.

The correction data includes a plurality of correction values assigned to each division Ra. A division Ra is an area including a prescribed number of pixels in the display area 2a of the display panel 2. The division Ra includes 8×8 pixels as illustrated in FIG. 5, for example. The same correction value is assigned to all pixels in a single division Ra. Each division Ra in the display area 2a is identified by coordinates (X, Y), for example.

In Step S5 of FIG. 4, the PC controller 30 first extracts luminance of the reference tone in the captured image from the luminance distribution of the display area in the captured image indicated by the captured image data based on the image data of the reference image. The PC controller 30 detects areas with luminance deviating from the luminance of the extracted reference tone, deviations in luminance, and the like for each division Ra in the display area 2a in the captured image. The PC controller 30 then generates the correction data by performing a calculation process through which a correction value of the tone value is calculated for correction of the detected deviation for each division Ra based on a prescribed gamma characteristic curve.

Next, the PC controller 30 sets the generated correction data to the display panel 2 (S6). In Step S6, the PC controller 30 first converts the generated correction data to a prescribed format. The prescribed format is a format for the panel control circuit 14 to perform correction of display unevenness, and is expressed by for example a parameter of a calculation formula for performing correction according to the correction value. Next, the PC controller 30 writes information of the converted correction data to the memory 21 of the display panel 2.

The PC controller 30 then sets the correction data to the display panel 2 undergoing processing (S6), thereby ending the process in the flowchart. Upon ending the process in the flowchart on one display panel 2, the correction system 1 moves onto the next display panel 2 as a display panel 2 undergoing processing and performs the same process.

When determining that an abnormality has been detected in the display area 2a in the captured image (YES in S4), the PC controller 30 for example notifies via the PC display section 34 of information expressing that an abnormality has been detected (S7). FIG. 6 illustrates a display example of the PC display section 34 in Step S7.

In FIG. 6, the PC display section 34 is displaying the captured image indicated by the captured image data acquired in Step S2. The PC display section 34 is also displaying a message 50 indicating an abnormality location in the display area 2a in the captured image as information related to the detected abnormality. The abnormality location is a location in which abnormal luminance difference that is not due to display unevenness is assumed to exist in the display area 2a. The abnormality location is detected in the abnormality detection process of Step S3 according to the present embodiment.

Referring back to FIG. 4, the PC controller 30 notifies of the information expressing that an abnormality has been detected (S7), and then ends the process of the flowchart without generating correction data for the display panel 2 undergoing processing (S6).

During generation of correction data for a display panel 2 in the correction system 1, the PC 13 stops generating correction data for the display panel 2 by ending the process described above without performing the process of Step S6 when an abnormality has been detected (YES in S4). Through the above, an outflow of defective display panels 2 due to generation of faulty correction data can be obviated.

Also when an abnormality has been detected (YES in S4), the user can recognize the source of the abnormality because the abnormality location is displayed as illustrated in FIG. 6 in the abnormality notification in the PC display section 34 (S7).

Note that the abnormality notification is not limited to the example in FIG. 6, and detection of an abnormality may be notified of without displaying a specific abnormality location, for example. In this case, detection of the abnormality location may be omitted from the abnormality detection process (S3).

### 2-3. Abnormality Detection Process

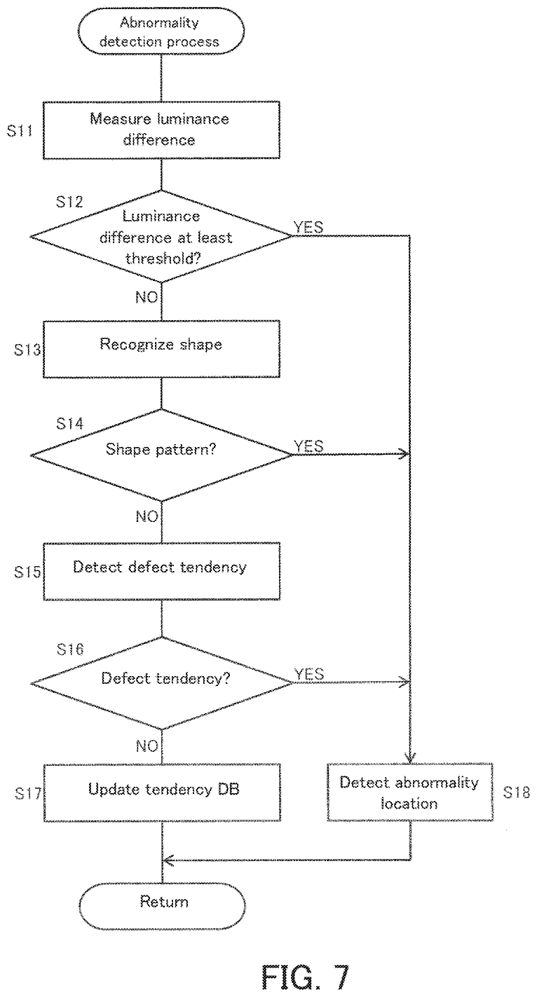

The following describes the abnormality detection process in Step S3 of FIG. 4 in detail with reference to FIGS. 7 and 8. FIG. 7 is a flowchart depicting the abnormality detection process in the correction system 1. FIG. 8 is a diagram for describing divisions for measuring luminance difference in the abnormality detection process.

Each process depicted in the flowchart of FIG. 7 is performed by the PC 13 in the correction system 1. At the start of the flowchart, the tendency DB 31a is recorded in the storage 31. The tendency DB 31a is for example a database which manages the tendency of luminance difference measured for a prescribed upper limit number of display panels 2 that have previously undergone processing.

The PC controller 30 of the PC 13 first measures luminance difference in the display area 2a in the captured image indicated by the captured image data (S11) based on the captured image data acquired in Step S2 of FIG. 4. The following describes the divisions for measuring luminance difference in the display area 2a in Step S11 using FIG. 8.

FIG. 8 illustrates the arrangement of divisions Rb for measuring luminance difference in the display area 2a. As illustrated in FIG. 8, the divisions Rb for measuring luminance difference divide the display area 2a into a matrix. The divisions Rb for measuring luminance difference are for example separately set so as to have a size independent of the divisions Ra (FIG. 5) for generating correction data.

In Step S11, the PC controller 30 first extracts respective luminance of the divisions Rb for measuring luminance difference based on the captured image indicated by the captured image data. The PC controller 30 then measures luminance difference between divisions Rb for measuring luminance difference that are adjacent to each other in the X or Y direction in the display area 2a in the captured image. The measurement of luminance difference is performed on all of the divisions Rb for measuring luminance difference in the display area 2a.

Referring back to FIG. 7, the PC controller 30 then determines whether or not the measured luminance difference is equal to or larger than a first threshold based on the result of measurement of luminance difference (S12). The first threshold is a value indicating a threshold between abnormal luminance difference and luminance difference due to display unevenness in the display area 2a, and is set by the user according to for example measurement of luminance difference existing when a foreign object 40 (FIG. 3A) is attached. For example, the PC controller 30 advances to “YES” when the highest luminance difference of a plurality of luminance differences measured between the respective divisions Rb for measuring luminance difference is equal to or larger than the first threshold, and advances to “NO” when the greatest luminance difference is less than the first threshold.

When determining that the measured luminance difference is equal to or larger than the first threshold (YES in Step S12), the PC controller 30 detects the abnormality location in the display area 2a in the captured image (S18). For example, when advancing to “YES” in Step S12, the PC controller 30 extracts all of the divisions Rb in which luminance difference is equal to or larger than the first threshold, and detects the location of each extracted division Rb as an abnormality location (S18).

When determining that the measured luminance difference is less than the first threshold by contrast (NO in S12), the PC controller 30 recognizes the shape formed by the distribution of luminance difference in the display area 2a (S13). For example, the PC controller 30 performs an image recognition process such as pattern recognition or edge detection on the image expressing the distribution of luminance difference in the display area 2a and recognizes the shape formed by the distribution of luminance difference, that is, the shape of an area formed by connecting the same or approximate luminance differences. The image undergoing the image recognition process may be an image in which the measured luminance is assigned between each division Rb for measuring luminance difference, or the captured image acquired in Step S2 of FIG. 4.

Next, the PC controller 30 determines whether or not a prescribed shape pattern exists in the distribution of luminance difference in the display area 2a based on a result of shape recognition (S14). The prescribed shape pattern is a shape assumed to be caused by a scratch to the laminate, a shadow of an external member, a reflection of external light, or the like occurring in the display area 2a in the captured image. The prescribed shape pattern is for example set to a geometrical shape such as the line 41, the rectangle 42, or the circle 43 (refer to FIG. 3B).

When determining that the prescribed shape pattern exists (YES in S14), the PC controller 30 detects the position of the shape pattern in the display area 2a as an abnormality location (S18).

When determining that the prescribed shape pattern does not exist by contrast (NO in S14), the PC controller refers to the tendency DB 31a stored in the storage 31 and detects a defect tendency in luminance differences measured for the display panels 2 (S15). In the tendency DB 31a, for example, information is recorded expressing a defect tendency area extracted in the upper limit number of display panels 2 previously having undergone processing. The defect tendency area is an area with luminance difference assumed to be due to a defect tendency in the display area 2a of each display panel 2 (refer to FIG. 3C).

In Step S15, the PC controller 30 extracts, as a defect tendency area, an area in which the luminance difference in the display area 2a in the captured image is equal to or larger than the second threshold based on the current result of measuring luminance difference in Step S11. The second threshold is not an apparently abnormal luminance difference, but is a value indicating a reference of luminance difference that may exhibit a defect tendency when existing repeatedly, and is set to a value smaller than the first threshold.

Next, the PC controller 30 detects, as a defect tendency, a case where a defect tendency area overlaps in equal to or larger than a prescribed number of display panels 2 based on the positions and ranges of the defect tendency area currently extracted from the result of measurement of luminance difference and the previous defect tendency areas in the tendency DB 31a (refer to FIG. 3C). The prescribed number is appropriately set to for example eighty percent of the upper limit number.

Based on the detection process of Step S15 as described above, the PC controller 30 determines whether or not a defect tendency has been detected (S16).

When determining that a defect tendency has not been detected (NO in S16), the PC controller 30 adds the information expressing the defect tendency area currently extracted in Step S15 to the tendency DB 31a of the storage 31 to update the tendency DB 31a (S17).

After updating the tendency DB 31a (S17), the PC controller 30 finishes the process of Step S3 in FIG. 4. In this case, the PC controller 30 advances to “NO” in Step S4 of FIG. 4.

When determining that a defect tendency has been detected by contrast (YES in S16), the PC controller 30 updates the tendency DB 31a in the same manner as in Step S17, and then detects as an abnormality location an overlapping part in the current and previous defect tendency areas of least the prescribed number of display panels 2 (S18).

The PC controller 30 finishes the process of Step S3 in FIG. 4 as a result of detection of the abnormality location (S18). In this case, the PC controller 30 advances to “YES” in Step S4 of FIG. 4.

By performing the above process, various abnormalities in which luminance difference exists that are not thought to be due to display unevenness in the display area 2a in the captured image can be detected based on the luminance difference in the captured image for generating correction data (S12, S14, and S16). By the threshold determination in Step S12, for example, a case where excessive luminance difference exists due to the presence of the foreign object 40 or the like attached to a display panel 2 can be detected as an abnormality (refer to FIG. 3A).

Furthermore, even in a case where there is no excessive luminance difference in the display area 2a in the captured image (NO in S12), a case where there is an abnormal shape such as one of the examples in FIG. 3B can be detected as an abnormality (S14) by recognizing the shape formed by the distribution of luminance difference (S13). Furthermore, by performing the process of Step S13 after advancement to “NO” in Step S12, a burden of processing necessary to recognize the shape in the abnormality detection process (S13) can be reduced.

Even in a case where there is no excessive luminance difference in the display area 2a in the captured image (NO in S12), the presence of a defect tendency area 44 such as the example in FIG. 3C can be detected as an abnormality (S16) by referring to the tendency DB 31a to detect a defect tendency (S15). Furthermore, by performing the process of Step S15 after advancing to “NO” in Steps S12 or S14, the burden of processing necessary to detect a defect tendency in the abnormality detection process (S15) can be reduced.

Note that although the processes of Steps S11 to S17 are performed in the stated order in the example described above, the present invention is not limited as such. The order of the processes of Steps S11 and S12, the processes of Steps S13 and S14, and the processes of Steps S15 and S16 may each be appropriately interchanged. Furthermore, any of the following may be omitted: the processes of Steps S11 and S12; the processes of Steps S13 and S14 and the processes of Steps S15 and S16, or only one of the foregoing may be performed.

### 3. Summary

The correction system 1 according to the present embodiment as described above generates correction data for correcting display unevenness of display panels 2. The correction system 1 includes the signal source 11, the camera 12, and the PC 13. The signal source 11 outputs a signal to cause a prescribed reference image to be displayed on a display panel 2. The camera 12 generates a captured image by capturing an image of the reference image displayed on the display panel 2 based on the signal from the signal source 11. The PC 13 generates the correction data to be set to the display panel 2 based on the captured image. The PC 13 detects an abnormality in the display area 2a in the captured image based on luminance difference that is difference in luminance between a plurality of prescribed areas (divisions Rb for measuring luminance difference) included in the display area 2a of the display panel 2 in the captured image (S3).

In the above correction system 1, an abnormality in the display area 2a can be detected based on luminance difference in the captured image for generating correction data. Through the above, when the correction system 1 generates correction data of display unevenness for each display panel 2, an outflow of defective display panels 2 with faulty correction data due to abnormal luminance difference in the captured image can be prevented.

The PC 13 according to the present embodiment detects an abnormality based on luminance difference between mutually adjacent divisions Rb among the divisions Rb for measuring luminance difference. Through the above, luminance difference that is due to a sharp change between the adjacent divisions Rb and that is not thought to be due to display unevenness can be easily detected as an abnormality.

The PC 13 according to the present embodiment also determines whether or not the luminance difference is equal to or larger than a first threshold (S12), and detects an abnormality when determining that the luminance difference is equal to or larger than the threshold (YES in S12). Through the above, existence of excessive luminance difference can be detected as an abnormality.

The PC 13 according to the present embodiment also recognizes the shape formed by the distribution of luminance difference in the display area 2a (S13) to detect an abnormality. Through the above, a case where a shape not thought to be due to display unevenness is reflected in the display area 2a in the captured image can be detected as an abnormality.

The PC 13 according to the present embodiment also includes the storage 31. The storage 31 stores therein information expressing an area (defect tendency area) with luminance difference that is equal to or larger than a second threshold in each display area 2a in the captured images of the plurality of display panels 2 as the tendency DB 31a. The PC 13 refers to the tendency DB 31a recorded in the storage 31, and detects an abnormality when the defect tendency area with luminance difference that is equal to or larger than the second threshold overlaps in at least a prescribed number of display panels 2 (S16). Through the above, a case where there is a defect tendency such as the defect tendency area overlapping in the display panels 2 can be detected as an abnormality.

The PC 13 according to the present embodiment also includes the PC display section 34 which notifies of information related to a detected abnormality. Through the above, the user can know that an abnormality has been detected in the display area 2a in the captured image by the notification of the PC display section 34.

The PC 13 according to the present embodiment also stops generating correction data upon detecting an abnormality (YES in S4). Through the above, an outflow of defective display panels 2 due to generation and setting of faulty correction data because of an abnormality in the display area 2a in the captured image can be obviated.

In the example described above using the flowchart of FIG. 4, the abnormality detection process (S3) is performed before correction data is generated (S5), but the present invention is not limited as such. For example, the processes of Steps S3 and S5 may be performed in parallel. When an abnormality is detected in the abnormality detection process (S3) in this case, the PC controller 30 of the PC 13 may interrupt the process of Step S5. This also allows the generation of correction data to be stopped when the PC 13 has detected an abnormality and allows an outflow of defective display panels 2 to be easily prevented.

### Additional Embodiments

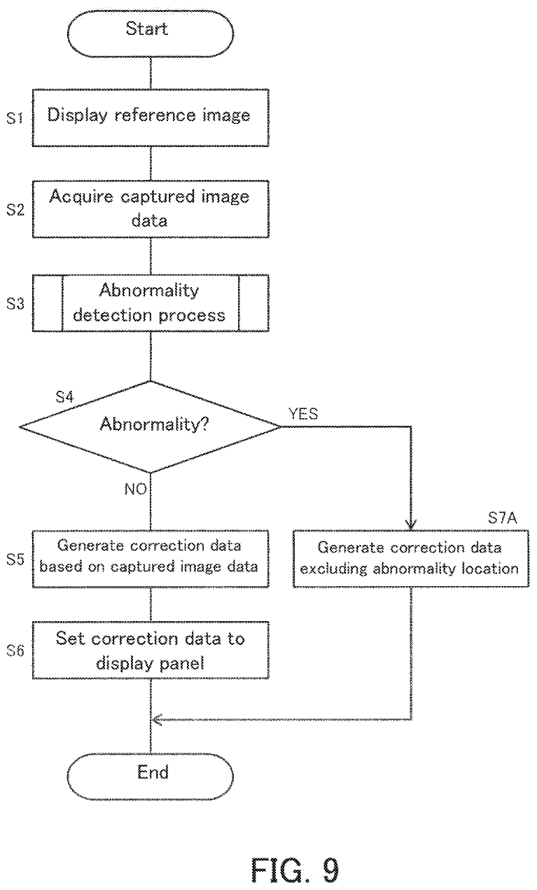

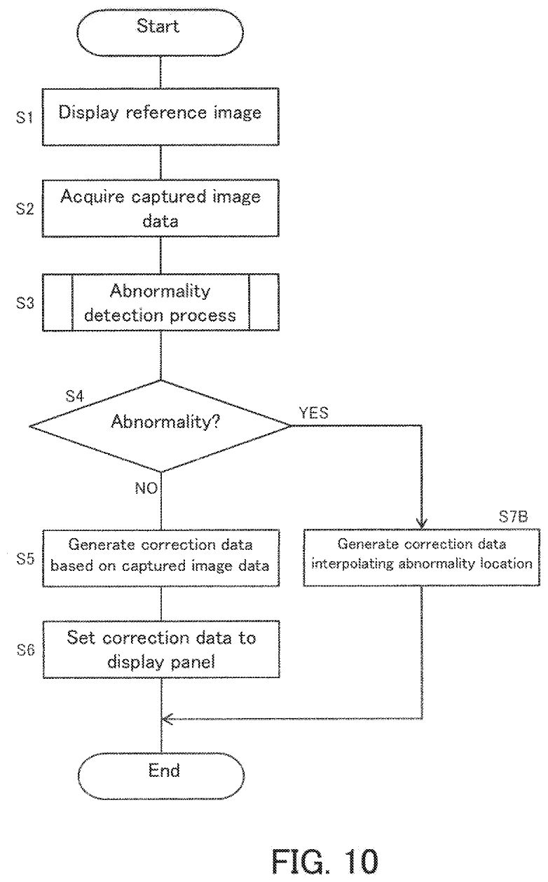

As described above in the first embodiment, the generation of correction data is stopped when the PC 13 in the correction system 1 has detected an abnormality based on luminance difference in the captured image. However, the present invention is not limited as such. For example, the abnormality location may be excluded or interpolated when generating correction data. The following describes the present example using FIGS. 9 and 10.

FIG. 9 is a flowchart depicting a first variation of the operation of the correction system 1. According to the present variation, the PC controller 30 of the PC 13 performs a process of Step S7A instead of Step S7 in which notification of an abnormality is performed in the flowchart of FIG. 4. In Step S7A, the PC controller 30 excludes the abnormality location in the display area 2a in the captured image based on a result of detection of the abnormality location (S18 in FIG. 7) in the abnormality detection process (S3) when generating correction data. Specifically, the PC controller 30 for example calculates a correction value for each division Ra other than a division Ra which overlaps with a division Rb detected as an abnormality location in the abnormality detection process and includes the correction values of the result of calculation in the correction data.

According to the present variation as described above, the PC 13 detects the abnormality location in the display area 2a in the captured image based on luminance difference (S18), and excludes the abnormality location in the display area when generating correction data (S7A). Through the above, correction data of parts other than an abnormality location can be generated even when there is an abnormality in the display area 2a in the captured image, and thus, efficiency of the process in the correction system 1 can be improved.

FIG. 10 is a flowchart depicting a second variation of the operation of the correction system 1. According to the present variation, the PC controller 30 generates correction data so as to interpolate an abnormality location (S7B) instead of Step S7A of the first variation. Specifically, the PC controller 30 first calculates a correction value for each division Ra other than a division Ra which overlaps with a division Rb detected as an abnormality location in the same manner as the process of Step S7A. Next, the PC controller 30 for example calculates a correction value for each of the remaining divisions Ra for which a correction value has not been calculated so as to interpolate with the correction value calculated for divisions Ra surrounding the remaining divisions Ra, and includes the correction values for all divisions Ra in the correction data.

According to the present variation as described above, the PC 13 detects an abnormality location in the display area 2a in the captured image based on luminance difference (S18), and generates correction data for interpolation of a correction value for the abnormality location based on a correction value for an area except the abnormality location in the display area 2a (S7B). Through the above, generation of faulty correction data is prevented by interpolation even in a case where an abnormality is detected in the display area 2a in the captured image, and thus, the efficiency of the process in the correction system 1 can be improved without generating defective display panels 2.

As described in each of the above embodiments, luminance difference between adjacent divisions Rb is calculated (S11) in the abnormality detection process (FIG. 7), but the measurement of luminance difference is not limited as such. Luminance difference may be calculated between divisions Rb with various intervals and used for various abnormality detection.

The divisions Rb for measuring luminance difference according to each of the above embodiments are also set differently from the divisions Ra for generating correction data, but may be set as the same.

Also in the examples described in each of the above embodiments, the reference image is set in a grayscale. However, the reference image is not limited as such, and may be set for example in a prescribed tone of each single color among three colors (four colors when pixels are configured as four colors): red, green, and blue (RGB). In this case, the correction data is generated for a reference image in each color.

Furthermore, the correction system 1 may use a plurality of reference images set in grayscale or each single color. In this case, reference tones according to the respective reference images are set for example from intermediate tones of the respective colors.

In addition, in the examples described in each of the above embodiments, the PC display section 34 is used as an example of a notifying section in the correction system 1. Examples of the notification section may also include a speaker, a speech synthesizer, a buzzer, and a lamp controlled by the PC 13 instead of or in addition to the PC display section 34.

Also according to each of the above embodiments, the PC 13 is used as an example of a control device in the correction system 1. However, a control device using various information processing devices may be provided instead of the PC 13. Furthermore, the control device and the signal source may be configured as integrated with each other for example through use of an information processing device in which the signal source is integrally included.

In addition, an example is described in each of the above embodiments in which the display panel 2 undergoing processing in the correction system 1 is a liquid crystal panel, but the present invention is not limited as such. For example, the present invention may also be applied to an organic EL display panel.

1. A correction system which generates correction data for correcting display unevenness of a display panel, the correction system comprising:
a signal source configured to output a signal to cause a prescribed reference image to be displayed on the display panel;
an image capture device configured to generate a captured image by capturing an image of the reference image displayed on the display panel based on the signal; and
a control device configured to generate correction data for the display panel based on the captured image, wherein
the control device detects an abnormality in a display area in the captured image based on luminance difference which is a difference in luminance between a plurality of prescribed areas included in the display area of the display panel in the captured image.

2. The correction system according to claim 1, wherein
the control device detects the abnormality based on the luminance difference between mutually adjacent prescribed areas among the prescribed areas.

3. The correction system according to claim 1, wherein
the control device
determines whether or not the luminance difference is equal to or larger than a prescribed threshold, and
detects the abnormality when the luminance difference is determined to be equal to or larger than the prescribed threshold.

4. The correction system according to claim 1, wherein
the control device detects the abnormality by recognizing a shape formed by distribution of the luminance difference in the display area.

5. The correction system according to claim 1, wherein
the control device
includes storage configured to record information expressing an area with luminance difference that is equal to or larger than a predetermined value in a display area in a captured image of each of a plurality of display panels,
refers to the information recorded in the storage, and
detects the abnormality when an area with luminance difference of equal to or larger than the predetermined value overlaps in at least a predetermined number of the display panels.

6. The correction system according to claim 1, wherein
the control device includes a notification section configured to notify of information related to the detected abnormality.

7. The correction system according to claim 1, wherein
the control device stops generating the correction data upon detecting the abnormality.

8. The correction system according to claim 1, wherein
the control device
detects an abnormality location in the display area in the captured image based on the luminance difference, and
generates the correction data for an area excluding the abnormality location in the display area.

9. The correction system according to claim 1, wherein
the control device
detects an abnormality location in the display area in the captured image based on the luminance difference, and
generates the correction data for interpolation of a correction value for the abnormality location based on a correction value for an area except the abnormality location in the display area.
